(19) United States
(12) Patent Application Publication
(10) Pub. No.: US 2015/0366147 A1
(43) Pub. Date: Dec. 24, 2015

(54) Aquatic Cultivation Method For Woody And Drought-Tolerant Plants

(71) Applicant: SUNRISE AGARWOOD BIOTECH CORPORATION, Taipei City (TW)

(72) Inventor: Wen-Yi Gau, Taipei City (TW)

(21) Appl. No.: 14/309,898

(22) Filed: Jun. 20, 2014

(51) Int. Cl. A01G 17/00

(52) U.S. Cl. CPC A01G 17/005

(57) ABSTRACT

An aquatic cultivation method for woody and drought-tolerant plants creates a symbiotic system of stable structure by steps of: (1) placing a seed in a pan for three to four weeks to grow an aquatic plant; (2) taking the aquatic plant out of the pan and removing dirt; (3) dipping the dirt-free aquatic plant into a beaker filled with a cultural liquid of somatotropic hormone for two to three hours; (4) taking out the aquatic plant and placing it into a container; (5) filling a substance into the container for securing the aquatic plant placed inside; (6) positioning the container on a water tank filled with water that the root of the aquatic plant can contact the water surface; and (7) completing cultivation when the root of the aquatic plant naturally extending into the water as adopted to an aquatic environment inside the water tank through time.

### (a) TECHNICAL FIELD OF THE INVENTION

The present invention is related to an aquatic cultivation method for woody and drought-tolerant plants, particularly a cultivation method utilizing a characteristic of aquatic plants and a food chain relationship between carbon-dioxide absorbed and oxygen produced by plants and carbon-dioxide produced by fishes so as to constitute a balanced ecological environment at small scale that is low at cost from both natural correlation and stable structure for creating a symbiotic cultivation method.

### (b) DESCRIPTION OF THE PRIOR ART

An aquatic cultivation of the prior art is shown in FIG. 1 illustrating a structure of woody plant by aquatic cultivation that includes a water tank 1″, a water 2″ inside the water tank 1″, a fish 3″ inside the water 2″ and an aquatic plant 4″ as inserted into the water tank 1″ with a root 41″ of the aquatic plant 4″ immersed in the water 2″. However the aforesaid structure is unstable that the aquatic plant 4″ could fall into the water 2″ due to either external force or other causes resulting in a rotten plant from dipping in water for a long period of time. Thereby the aquatic cultivation of the prior art becomes unsuccessful at significant loss after long time investment. Therefore there is a demand to achieve a stable structure for cultivation in terms of providing the best care to the delicate aquatic plants.

The advantages and intents of the present invention are illustrated and understood from the following descriptions with reference to the associated figures.

### SUMMARY OF THE INVENTION

An objective of an aquatic cultivation method for woody and drought-tolerant plants of the present invention is to utilize a characteristic of aquatic plants and a food chain relationship between carbon-dioxide absorbed and oxygen produced by plants and carbon-dioxide and fertilizer produced by fishes so as to constitute a balanced ecological environment at small scale that is low at cost from both natural correlation and stable structure for creating a symbiotic cultivation method.

An aquatic cultivation method for woody and drought-tolerant plants includes below steps:

(1) placing a seed in a cultivation pan for three to four weeks in order to grow into an aquatic plant;

(2) taking the aquatic plant as placed for three to four weeks out of the cultivation pan and removing all dirt;

(3) dipping the aquatic plant with dirt removed into a beaker filled with a cultural liquid of somatotropic hormone for two to three hours in order to saturate a root of the aquatic plant with the cultural liquid;

(4) taking out the aquatic plant dipped in the cultural liquid of somatotropic hormone for two to three hours and then placing the aquatic plant into a container, which has a bottom provided with at least an opening through which the root of the aquatic plant is exposed outside the container;

(5) filling a substance, which can be one of the seaweed, artificial sponge or cotton, into the container for securing the aquatic plant placed inside the container;

(6) positioning the container on top of a water tank filled with a water as set to a temperature range of 15 to 30° C. that the root of the aquatic plant placed inside the container can contact a surface of the water; and

(7) completing cultivation when the root of the aquatic plant naturally extending into the water filled within the water tank as adopted to an aquatic environment inside the water tank through time.

### BRIEF DESCRIPTION OF THE DRAWINGS

FIG. 1 is a schematic structure diagram of aquatic cultivation for woody plants of the prior art.

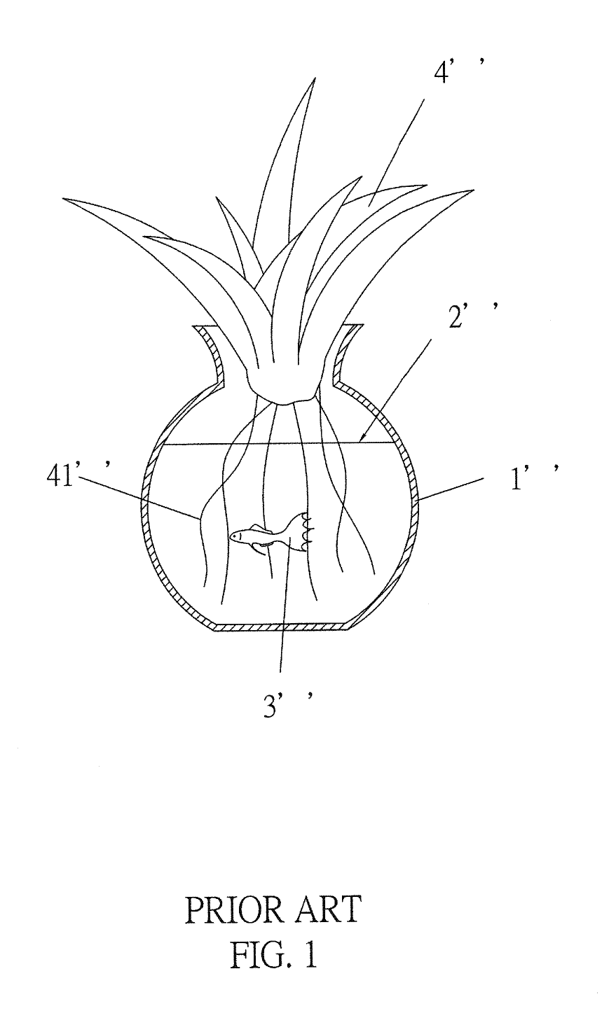

FIG. 2 is a schematic diagram of a disassembled embodiment illustrating an aquatic cultivation method for woody and drought-tolerant plants of the present invention.

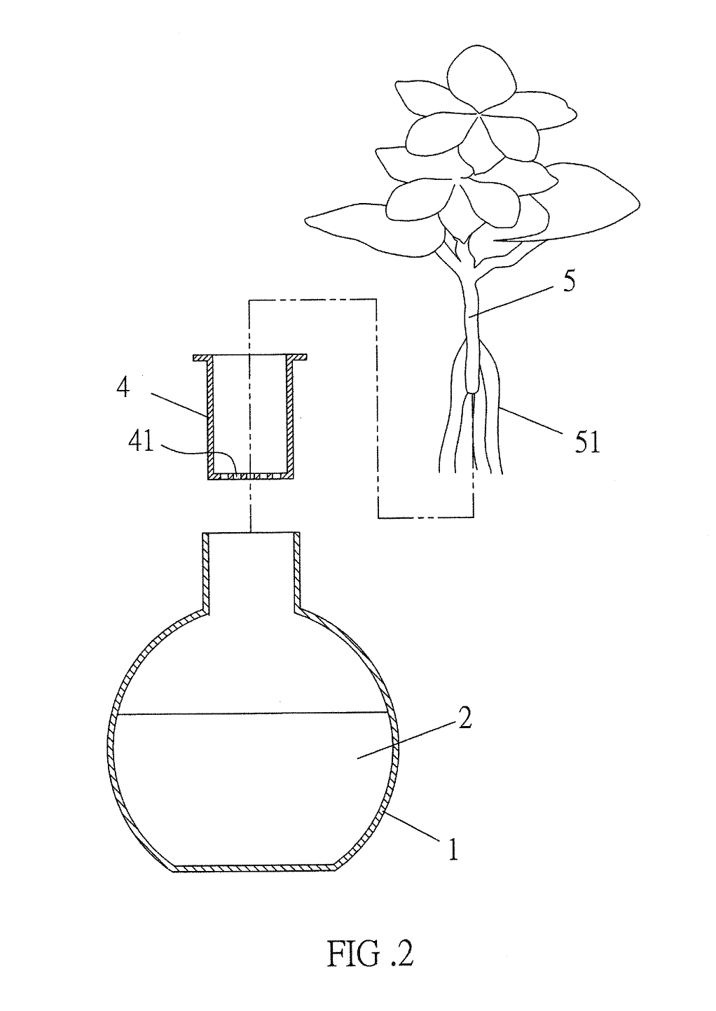

FIG. 3 is a schematic diagram of an assembled embodiment illustrating the aquatic cultivation method for woody and drought-tolerant plants of the present invention.

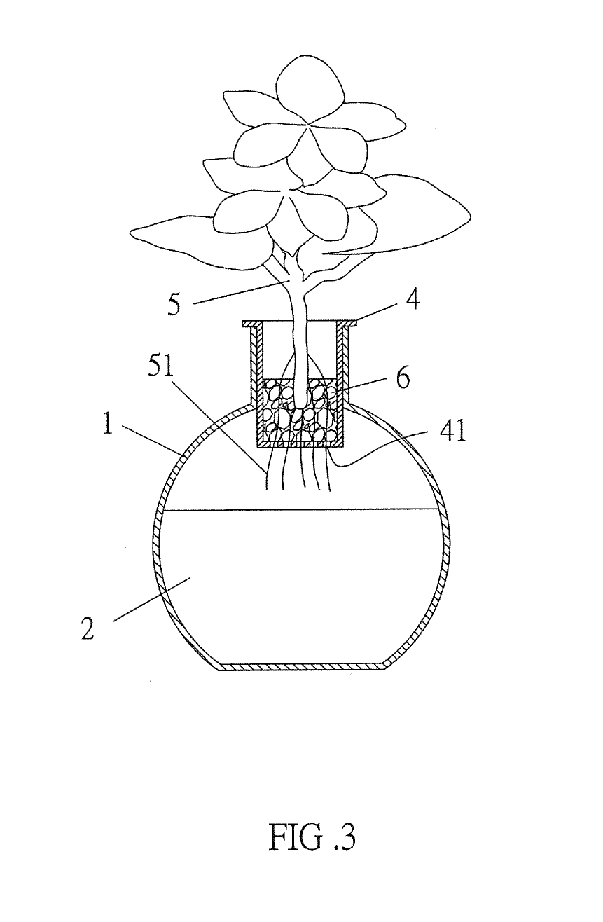

FIG. 4 is a schematic diagram illustrating an aquatic plant before being adapted to an aquatic environment of the present invention.

FIG. 5 is a schematic diagram illustrating an aquatic plant after being adapted to the aquatic environment of the present invention.

FIG. 6 is a schematic diagram illustrating the aquatic cultivation method for woody and drought-tolerant plants with a marine animal of the present invention.

FIG. 7 is a flowchart of the aquatic cultivation method for woody and drought-tolerant plants of the present invention.

### DETAILED DESCRIPTION OF THE PREFERRED EMBODIMENTS

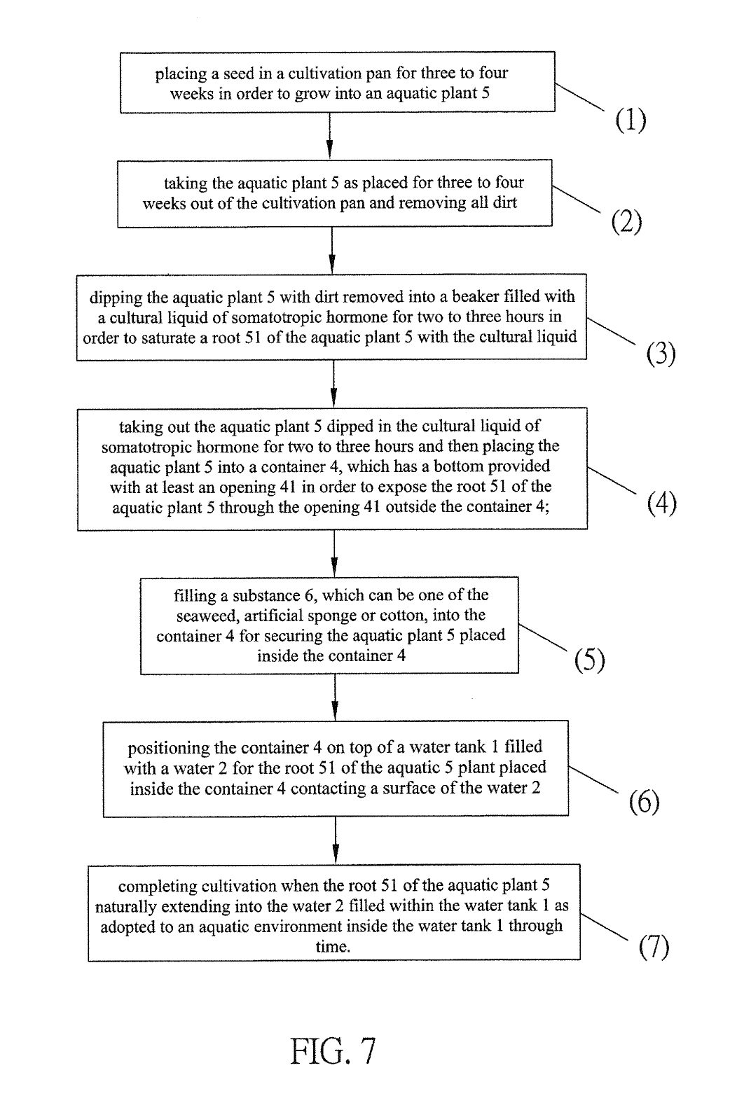

Please refer FIG. 7 illustrating an aquatic cultivation method for woody and drought-tolerant plants of the present invention including below steps:

(1) placing a seed in a cultivation pan for three to four weeks in order to grow into an aquatic plant 5;

(2) taking the aquatic plant 5 as placed for three to four weeks out of the cultivation pan and removing all dirt;

(3) dipping the aquatic plant 5 with dirt removed into a beaker filled with a cultural liquid of somatotropic hormone for two to three hours in order to saturate a root 51 of the aquatic plant 5 with the cultural liquid;

(4) taking out the aquatic plant 5 dipped in the cultural liquid of somatotropic hormone for two to three hours and then placing the aquatic plant 5 into a container 4, which has a bottom provided with at least an opening 41 in order to expose the root 51 of the aquatic plant 5 through the opening 41 outside the container 4;

(5) filling a substance 6, which can be one of the seaweed, artificial sponge or cotton, into the container 4 for securing the aquatic plant 5 placed inside the container 4;

(6) positioning the container 4 on top of a water tank 1 filled with a water 2, which is set to a temperature range of 15 to 30° C., such that the root 51 of the aquatic plant 5 placed inside the container 4 can contact a surface of the water 2; and

(7) completing cultivation when the root 51 of the aquatic plant 5 naturally extending into the water 2 filled within the water tank 1 as adopted to an aquatic environment inside the water tank 1 through time.

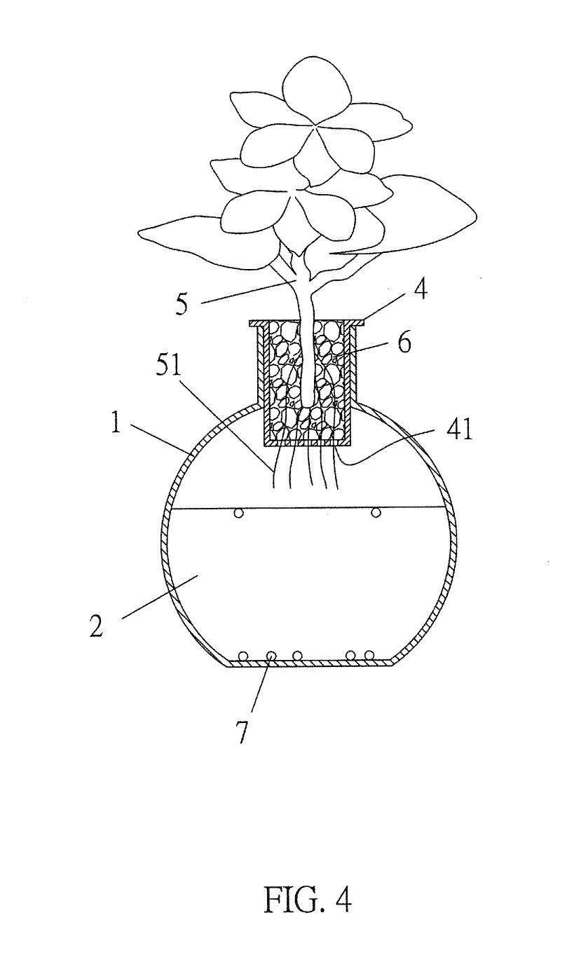

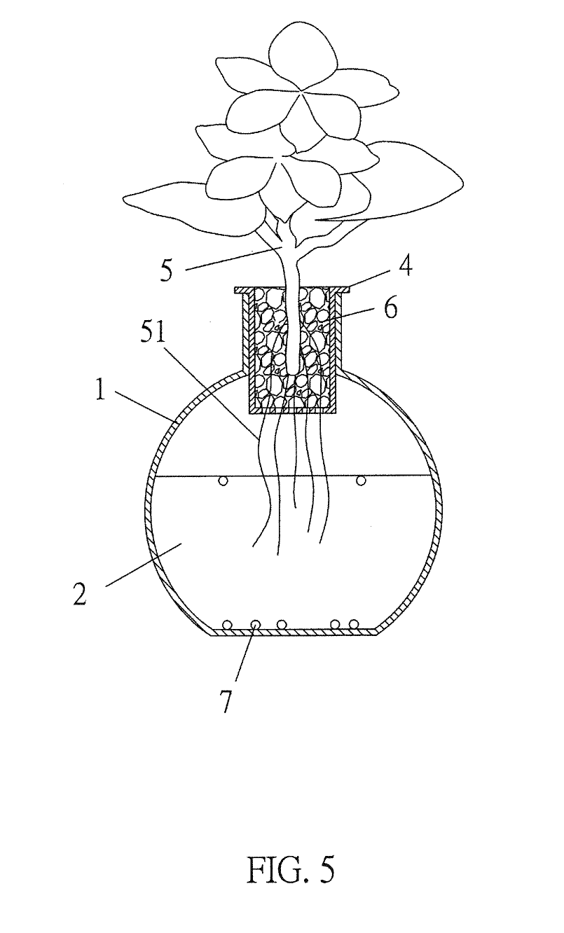

Please refer FIGS. 4 and 5. The water tank 1 can be further provided with fertilizer 7 in a solid state that nutrition absorption through the fertilizer 7 can be achieved when the root 51 of the aquatic plant 5 inside the container 4 contacts the water 2 inside the water tank 1.

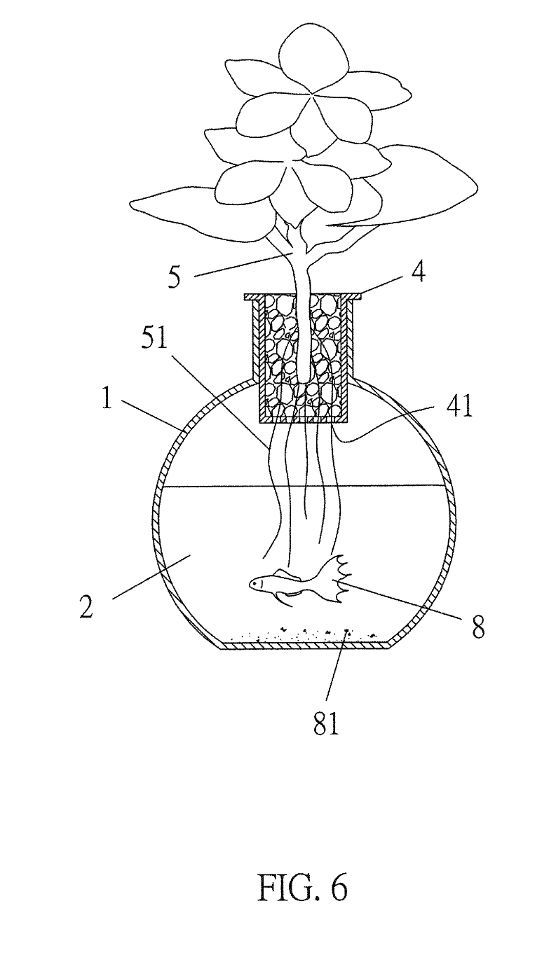

Please refer FIG. 6. The water tank 1 can be further provided with a marine animal 8, which can be a fish, so that the aquatic plant 5 absorbs carbon-dioxide from ambient air and then produces oxygen for sustaining the survival of the marine animal 8. Moreover, the excreta 81 from the marine animals 8 can be used as a fertilizer for the aquatic plant 5.

From the above-mentioned, the excreta 81 from the marine animals 8 can be used as a fertilizer for the aquatic plant 5 while the aquatic plant 5 absorbs carbon-dioxide from ambient air and then produces oxygen for sustaining the survival of the marine animal 8 such that the cultivation of the aquatic plant 5 can be achieved without contacting sun light. Further, the aquatic plant 5 can grow algae within an oxygen rich environment in which a virus cannot survive. The aquatic plant 5 of the present invention can be one of woody plants such as aquilaria tree, podocarpus so that the present invention is advantageous in utility. The structure of the present invention is so stable that the aquatic plant 5 will not fall into the water 2 due to either external force or other causes so as to eliminate the concern of a rotten plant from dipping in water for a long period of time.

It is understood that the foregoing description is that of the preferred embodiments of the present invention and that various changes and modifications may be made thereto without departing from the spirit and scope of the present invention as defined in the appended claims.

I claim:

1. An aquatic cultivation method for woody and drought-tolerant plants comprising steps of
(1) placing a seed in a cultivation pan for three to four weeks in order to grow into an aquatic plant;
(2) taking the aquatic plant as placed for three to four weeks out of the cultivation pan and removing all dirt;
(3) dipping the aquatic plant with dirt removed into a beaker filled with a cultural liquid of somatotropic hormone for two to three hours in order to saturate a root of the aquatic plant with the cultural liquid;
(4) taking out the aquatic plant dipped in the cultural liquid of somatotropic hormone for two to three hours and then placing the aquatic plant into a container having a bottom provided with at least an opening in order to expose the root of the aquatic plant through the opening outside the container;
(5) filling a substance into the container for securing the aquatic plant placed inside the container;
(6) positioning the container on top of a water tank filled with a water for the root of the aquatic plant placed inside the container contacting a surface of the water; and
(7) completing cultivation when the root of the aquatic plant naturally extending into the water filled within the water tank as adopted to an aquatic environment inside the water tank through time.

2. The aquatic cultivation method for woody and drought-tolerant plants of claim 1 wherein the substance in step (5) is one of seaweed, artificial sponge or cotton.

3. The aquatic cultivation method for woody and drought-tolerant plants of claim 1 wherein the water inside the water tank of step (6) is set to a temperature range of 15 to 30° C.
